(19) United States
(12) Patent Application Publication
(10) Pub. No.: US 2008/0254415 A1
(43) Pub. Date: Oct. 16, 2008

(54) System and Method for Training an Excavator Operator

(76) Inventor: J. Keith Barry, Saskatchewan (CA)

Correspondence Address: ADE & COMPANY INC., 2157 Henderson Highway, WINNIPEG, MB, R2G1P9, CA

(21) Appl. No.: 12/066,923

(22) PCT Filed: Sep. 16, 2005
(86) PCT No.: PCT/CA05/01413

§ 371 Date: Mar. 14, 2008

(51) Int. Cl. G09B 9/00; G09B 25/02

(52) U.S. Cl. 434/29; 434/401; 434/219; 37/195

(57) ABSTRACT

A training system and method of use thereof permit training of an operator to use ground excavating implements. A building structure is provided locating a plurality of operator seats therein at respective operator stations. A boom structure is mounted to the foundation externally of the building in association with each of the operator stations to permit an operator in training in one of the operator seats to control actual movement of a boom structure in visual proximity therewith using joystick controlled excavator hydraulics at the operator seat. A backhoe arm is used as a scaled down approximation of a track hoe with decreased operating pressure to represent a realistic responsiveness of the hydraulic controls.

### FIELD OF THE INVENTION

The present invention relates to a training system and a method of use of the training system for training an operator to use a ground excavating implement.

### BACKGROUND

Backhoes and track hoes, the latter commonly being referred to as an excavator, are two common types of ground excavating implements. Excavators in particular are very large heavy equipment in the range possibly of 40,000 to 70,000 lbs. Typical excavator construction includes a track base for movement across the ground which supports a rotating base pivotally thereon for rotation relative to the track base about a vertical axis. An operator seat and a boom structure are supported on the track base for rotation therewith. Use of the excavator to control the boom structure requires considerable skill and experience. It is costly and dangerous however to train new operators on existing equipment due to the considerable size and scale of the equipment in question.

Various simulators are known for training operators of excavator implements. Typical simulators involve an operator seat with simulated controls fed to a computer which generates artificial images for the operator to see. Such simulators are typically not sufficiently realistic as no feedback is provided and the responsiveness is not representative of actual equipment. In particular there is no feedback on the controls when resistance is encountered in use, for example when the boom structure is digging through the ground at various depths. Accordingly operators trained on such simulators commonly lack the required skill for proper safe operation of excavators in many instances.

### SUMMARY

According one aspect of the present invention there is provided a training system for training an operator to use a ground excavating implement, the system comprising:

a boom structure including a base mount, a boom element pivotally supported on the base mount, a stick element pivotally supported on the boom element and a bucket element pivotally supported on the stick element;

a foundation for supporting the base mount of the boom structure in fixed relation to the ground;

an operator seat for being supported in visual proximity to the boom structure; and

hydraulic controls supported at the operator seat for controlling pivotal movement of the elements of the boom structure.

According to a second aspect of the present invention there is provided a method for training an operator to use a ground excavating implement, the method comprising:

providing a boom structure including a base mount, a boom element pivotally supported on the base mount, a stick element pivotally supported on the boom element and a bucket element pivotally supported on the stick element;

supporting the base mount of the boom structure in fixed relation to the ground;

supporting an operator seat in visual proximity to the boom structure;

locating hydraulic controls at the operator seat which control pivotal movement of the elements of the boom structure; and

seating the operator at the operator seat for using the hydraulic controls to control the pivotal movement of the elements of the boom structure.

By providing a foundation for supporting the boom structure thereon with hydraulic controls on an operator seat in visual proximity to the boom structure, training an operator to control an actual boom can be accomplished relatively inexpensively in comparison to training operators on actual excavator equipment. Furthermore the foundation fixing the boom structure to the ground results in a much safer configuration to minimize dangers while training. Better training results as realistic response on the controls are achieved throughout the range of motion of the boom structure.

The operator seat is preferably fixed in relation to the foundation, centered in relation to the base mount of a boom structure.

Preferably, the boom element is pivotally supported in relation to the operator seat for movement approximately 180° about a vertical axis.

The operator seat is preferably supported within an interior of a building structure with the boom structure being supported outdoors such that the boom structure and operator seat are separated by a window permitting an operator to visually locate the boom structure therethrough.

There may be provided pilings in the ground spaced outwardly from the foundation in the direction which the boom structure extends for protecting the foundation against impacts from the boom structure.

The foundation preferably includes a wall mount for selective attachment of a commercially available boom structure thereon.

The hydraulic controls preferably comprise conventional excavator joystick controls supported on respective arms of the operator seat.

When the boom structure comprises a backhoe arm, the hydraulic controls are preferably operated at an operating pressure between 3000 and 4000 psi, but anything between 2500 and 5000 psi remains effective.

The boom structure may comprise one of a plurality of boom structures of similar configuration, each having an operator seat associated therewith housed in a common building.

The boom structures in this instance are preferably supported in pairs at opposing ends of a respective structural beam of the building.

An individual hydraulic pump may be provided for each of the boom structures.

Each boom structure may include an individual shutoff control in the form of a valve which freezes the hydraulic controls in addition to a master shutoff control for simultaneously shutting off hydraulic controls of all of the boom structures of the building by similarly freezing the hydraulic controls thereof.

A room divider is preferably supported between each adjacent pair of operator seats.

### BRIEF DESCRIPTION OF THE DRAWINGS

In the accompanying drawings, which illustrate an exemplary embodiment of the present invention:

FIG. 1 is a partly sectional elevational view of a module in which a pair of operator seats and associated boom structures of the training system are illustrated.

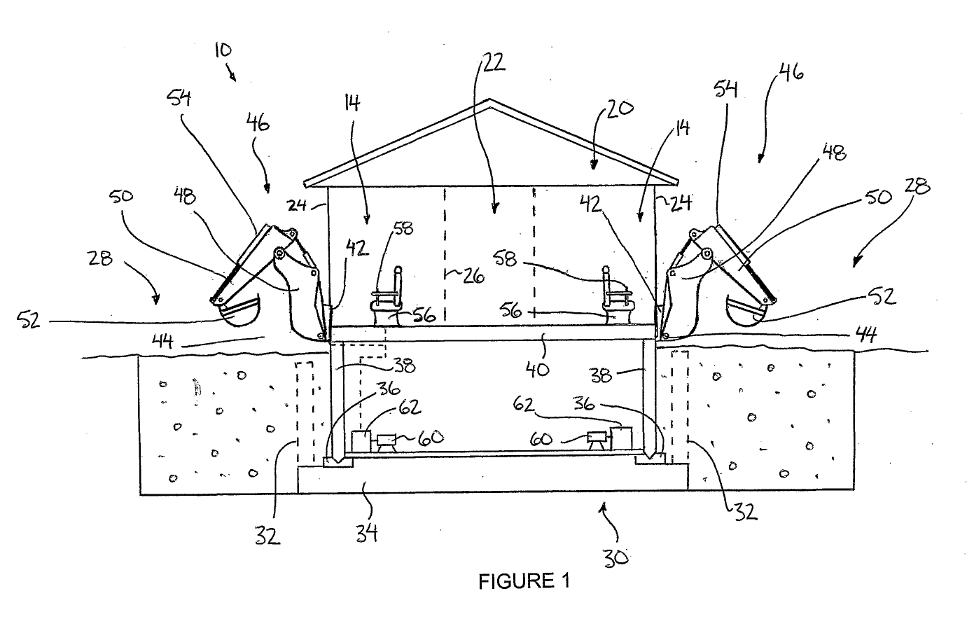

FIG. 2 is a top plan view of one of the operator seats and associated boom structure.

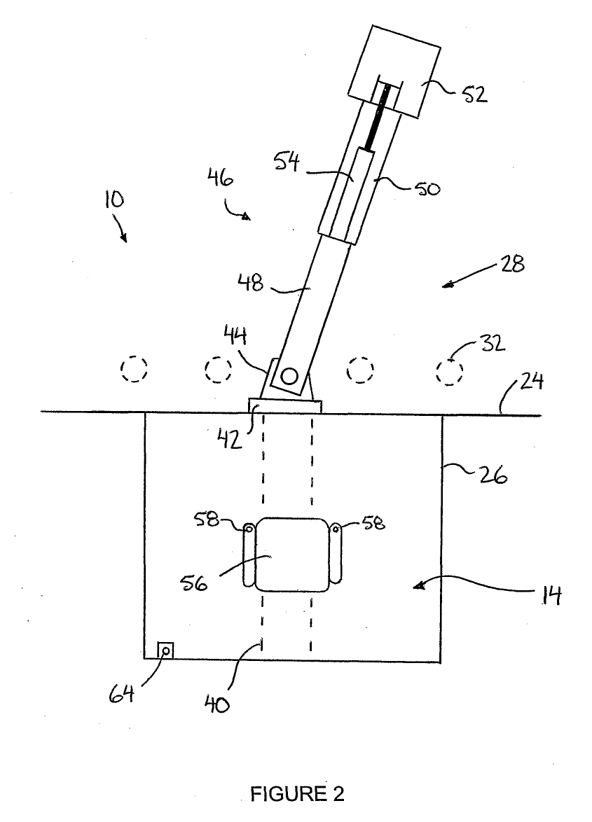

FIG. 3 is a plan view of a building configured as a training system according to the present invention.

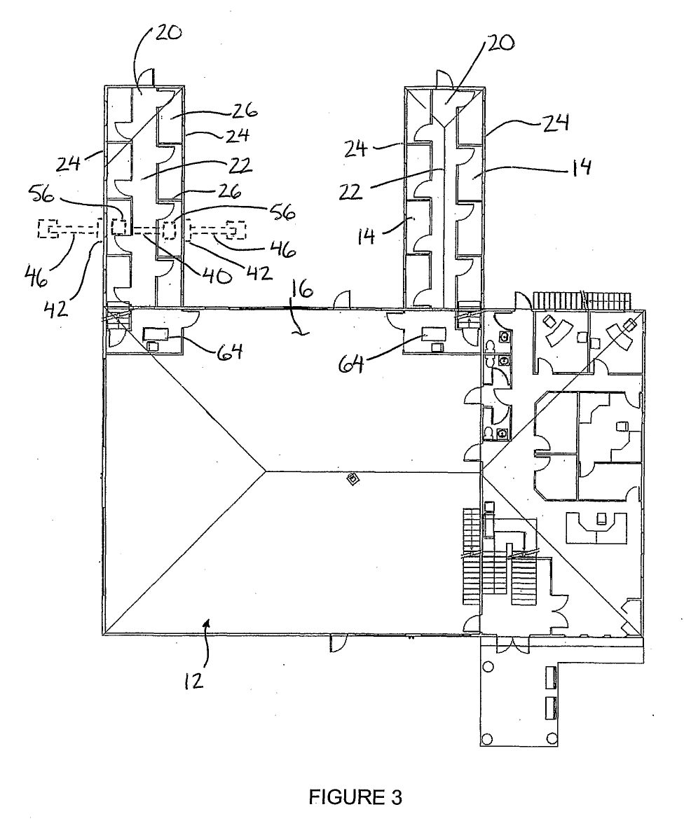

### DETAILED DESCRIPTION

Referring to the accompanying figures, there is illustrated a training system generally indicated by reference numeral 10. The system 10 is particularly useful for training an operator to use a ground excavating implement.

A building 12 is illustrated including the training system incorporated therein in which a plurality of individual operator stations 14 are provided. The building 12 includes a shop area 16, a classroom area which is not shown, office facilities 18 and a pair of training modules 20. Each module 20 is annexed to the building 12 and houses the operator stations 14 therein, organized in opposing pairs.

Each module is an elongate building having a central hall area 22 forming a walkway extending longitudinally down a center of the module. The operator stations 14 are located sequentially along each longitudinally extending side 24 of the module such that each station is located opposite a corresponding station in which each pair of stations faces away from one another. The operator stations are separated by dividers 26 and are opened to the central hall 22. The hall is connected to the remainder of the building 12 adjacent one end thereof so that the module projects outwardly from the building with considerable open space 28 being provided adjacent each longitudinally extending side of the module.

The foundation 30 of each module differs from the remainder of the foundation as it is reinforced with additional pilings 32 supported in the ground spaced outwardly from, the foundation walls. The foundation includes a base slab 34 forming the floor of a basement level below ground. Footings 36 are provided along opposing sides of the base slab 34 for supporting vertical columns 38 extending upwardly therefrom. A plurality of I beams 40 span horizontally between vertical columns 38 at the opposing longitudinal sides substantially at ground level spaced slightly above to define the floor of a main ground level of the module. The protective pilings 32 are embedded in the ground at spaced positions along the opposing longitudinal sides parallel to the columns 38 spaced slightly outwardly from the foundation.

Each station includes a wall mount 42 at the outside wall of the module for supporting the base mount of a boom structure 46 associated with that station. One I beam is associated with each opposing pair of stations so that the wall mounts 42 are secured to the opposing ends of the I beams.

The boom structure 46 includes a boom element pivotally supported on the base mount for movement relative to the wall mount 42 about a vertical axis and a horizontal axis. A stick element 50 is pivotally supported at the free end of the boom element 48 for relative pivotal movement about a horizontal axis. A bucket element 52 of the boom structure is pivotally supported on the free end of the stick element also about a respective horizontal axis. Pivotal movement between the elements and relative to the wall mount 42, fixed on the foundation which is fixed in relation to the ground, is controlled by a plurality hydraulic rams 54. The boom structure 46 comprises a conventional and commercially available backhoe arm in which the wall mount 42 is suitably adapted for selectively supporting the base mount of the commercially available boom structure readily thereon. The boom structure is permitted to pivot relative to the wall mount approximately 180° from side to side about the vertical axis thereof.

An operator seat 56 is supported at each operator station 14 in close proximity to the outer wall of the building. The operator seat 56 is centered with respect to the base mount 44 of the boom structure and faces outwardly towards the boom structure away from the opposing seat of the respective pair of stations on opposing sides of the module. The seat is fixed in orientation directly in front of a glass window pane which separates the operator seat located indoors from the boom structure outdoors. All of the parts of each operator station which are movable by hydraulic action are located outdoors.

Hydraulic controls are provided at the operator seat 56 for controlling movement of the boom structure in the form of a pair of joysticks 58 supported on respective arms of the seat in a configuration similar to conventional excavator hydraulic controls. The joysticks 58 are set up in SAE standard excavator pattern. In this configuration the lefthand joystick moves the stick in and out by forward and back movement thereof while swinging the boom side to side with left and right motion thereof. The righthand joystick is configured to raise and lower the boom by forward and reverse movement of the joystick relative to the operator while opening and closing the bucket with side to side movement of the joystick.

An individual motor 60 and hydraulic pump 62 are provided in the basement area below each of the stations so that one motor and pump is associated with each station and respective boom structure. A control station is provided for either shutting off any one station individually or simultaneously shutting all stations with a master control in which the shutoff in each instance freezes the hydraulics by means of a suitable valve. Operating pressure is typically selected between 3000 and 4000 psi but any pressure in the range of 2500 to 5000 psi remains effective. Normal excavators typically operate at pressures in the order of 5000 psi or more, but actual excavators include much larger and heavier boom structures than the backhoe structure as found in the present training system. By lowering the pressure associated with the lighter backhoe equipment, response and feel of the scaled down equipment for training better imitates the actual much heavier boom structure of an excavator operating at higher hydraulic pressure.

In use at least one instructor is provided in association with each module for overseeing the operators in training at the operator stations respectively which are separated by room dividers. The shutoff controls 64 are accessible to the instructor who would typically communicate with the students in training by a headphone and microphone configuration.

In accordance with the present invention, training of an operator to use ground excavating implements is accomplished by providing a scaled down boom structure as descried herein which is supported on a fixed foundation in relation to the ground. Seating the operator in a seat which is in visual proximity of the boom structure and which is equipped with hydraulic controls for controlling pivotal movement of the elements of the boom structure, the operator in training can effectively experience the actual feel and response of real equipment instead of relying on computer generated imagery. The instructor may required the students who are operators in training to accomplish various exercises, for example placement and removal of a ring on stick planted in the ground or manoeuvring about various man made obstacles placed outside within range of the boom structure. Suitable limits or stops are provided on the boom structure to prevent collision with the building or otherwise causing any damage. The pilings for example protect the foundation of the building from being impacted accidentally by operators in training controlling the boom structure outside the building.

While one embodiment of the present invention has been described in the foregoing, it is to be understood that other embodiments are possible within the scope of the invention. The invention is to be considered limited solely by the scope of the appended claims.

1. A training system for training an operator to use a ground excavating implement, the system comprising:
a boom structure including a base mount, a boom element pivotally supported on the base mount, a stick element pivotally supported on the boom element and a bucket element pivotally supported on the stick element;
a foundation for supporting the base mount of the boom structure in fixed relation to the ground;
an operator seat for being supported in visual proximity to the boom structure; and
hydraulic controls supported at the operator seat for controlling pivotal movement of the elements of the boom structure.

2. The system according to claim 1 wherein the operator seat is fixed in relation to the foundation.

3. The system according to claim 1 wherein the operator seat is centered in relation to the base mount of a boom structure.

4. The system according to claim 1 wherein the boom element is pivotally supported in relation to the operator seat for movement approximately 180° about a vertical axis.

5. The system according to claim 1 wherein the boom structure is supported outdoors for engagement of the ground with the bucket.

6. The system according to claim 1 wherein the operator seat is supported within an interior of a building structure.

7. The system according to claim 6 wherein the boom structure is supported outdoors and the boom structure and operator seat are separated by a window permitting an operator to visually locate the boom structure therethrough.

8. The system according to claim 1 wherein there is provided pilings in the ground spaced outwardly from the foundation in the direction which the boom structure extends.

9. The system according to claim 1 wherein the foundation includes a wall mount for selective attachment of a commercially available boom structure thereon.

10. The system according to claim 1 wherein the hydraulic controls comprise conventional excavator joystick controls supported on respective arms of the operator seat.

11. The system according to claim 10 wherein the boom structure comprises a backhoe arm in which the hydraulic controls are operated at an operating pressure between 2500 and 5000 psi.

12. The system according to claim 1 wherein the boom structure comprises one of a plurality of boom structures of similar configuration, each having an operator seat associated therewith housed in a common building.

13. The system according to claim 12 wherein the boom structures are supported in pairs at opposing ends of a respective structural beam of the building.

14. The system according to claim 12 wherein an individual hydraulic pump is provided for each of the boom structures.

15. The system according to claim 12 wherein each boom structure include an individual shutoff control in the form of a valve which freezes the hydraulic controls.

16. The system according to claim 12 wherein there is provided a master shutoff control for simultaneously shutting off hydraulic controls of all of the boom structures of the building by freezing the hydraulic controls thereof.

17. The system according to claim 12 wherein a room divider is supported between each adjacent pair of operator seats.

18. A method for training an operator to use a ground excavating implement, the method comprising:
providing a boom structure including a base mount, a boom element pivotally supported on the base mount, a stick element pivotally supported on the boom element and a bucket element pivotally supported on the stick element;
supporting the base mount of the boom structure in fixed relation to the ground;
supporting an operator seat in visual proximity to the boom structure;
locating hydraulic controls at the operator seat which control pivotal movement of the elements of the boom structure; and
seating the operator at the operator seat for using the hydraulic controls to control the pivotal movement of the elements of the boom structure.

19. The method according to claim 18 including fixing the operator seat in relation to the foundation.

20. The method according to claim 18 including supporting the operator seat centered in relation to the base mount of a boom structure.

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)
